(19) United States
(12) Patent Application Publication
(10) Pub. No.: US 2013/0151485 A1
(43) Pub. Date: Jun. 13, 2013

(54) APPARATUS AND METHOD FOR STORING TRACE DATA

(71) Applicant: Jae-Young KIM, Namyangju-si (KR)

(72) Inventor: Jae-Young KIM, Namyangju-si (KR)

(21) Appl. No.: 13/686,346

(22) Filed: Nov. 27, 2012

(30) Foreign Application Priority Data
Dec. 12, 2011 (KR) 10-2011-0133199

(51) Int. Cl. G06F 17/30

(52) U.S. Cl. CPC G06F 17/30002
USPC 707/693

(57) ABSTRACT

An apparatus and method to store trace data are provided. The apparatus includes a compression information generating unit configured to generate compression information to indicate the valid trace data in a trace data set. The apparatus further includes a compressing unit configured to extract the valid trace data from the trace data set based on the compression information. The apparatus further includes a write control unit configured to generate a write control signal for use in writing the valid trace data based on the compression information. The apparatus further includes a trace data buffer configured to store the valid trace data in response to the write control signal.

### CROSS-REFERENCE TO RELATED APPLICATION(S)

This application claims the benefit under 35 U.S.C. §119(a) of Korean Patent Application No. 10-2011-0133199, filed on Dec. 12, 2011, in the Korean Intellectual Property Office, the entire disclosure of which is incorporated herein by reference for all purposes.

### BACKGROUND

1. Field

The following description relates to a reconfigurable processor and a method for trace data management of a reconfigurable processor.

2. Description of the Related Art

Reconfigurable architecture refers to architecture capable of changing a hardware configuration of a computing device according to a task to be executed in order to provide an optimized hardware configuration to perform the task. Processing a task using hardware may have a lower efficiency compared to processing the task using software, especially when the task is modified or changed, since functions of the hardware are fixed. On the other hand, processing a task using software may result in lower processing speed compared to hardware-implemented processing, although software can be readily changed to be suitable for the task. The reconfigurable architecture has many advantages of both hardware and software. For instance, the reconfigurable architecture can be efficiently applied to digital signal processing including an iterative execution of the same task.

One type of reconfigurable architecture is a Coarse-Grained Array (CGA). The CGA is composed of a plurality of function units, and can be optimized for a task by changing connection states between the function units.

Trace data may be state information of a processing unit, e.g., a function unit. In the CGA, since the function units can operate independently of one another, trace data is generated per each function unit. Hence, an amount of trace data is increased in proportion to a number of the function units.

### SUMMARY

In one general aspect, there is provided an apparatus configured to store valid trace data, including a compression information generating unit configured to generate compression information to indicate the valid trace data in a trace data set. The apparatus further includes a compressing unit configured to extract the valid trace data from the trace data set based on the compression information. The apparatus further includes a write control unit configured to generate a write control signal for use in writing the valid trace data based on the compression information. The apparatus further includes a trace data buffer configured to store the valid trace data in response to the write control signal.

The write control unit is further configured to generate the write control signal such that a number of the valid trace data are successively stored in the trace data buffer without remaining space.

The write control signal includes a write enable and a write address with respect to the trace data buffer.

The apparatus further includes a compression information buffer configured to store the compression information.

The apparatus further includes a read control unit configured to generate a read control signal for use in reading the valid trace data based on the compression information stored in the compression information buffer, the read control signal including a read enable and a read address with respect to the trace data buffer.

The apparatus further includes a trace packet generating unit configured to generate a trace packet based on the valid trace data read in response to the read control signal.

The compression information generating unit is further configured to generate the compression information to indicate which function unit includes the valid trace data among the trace data set that includes pieces of trace data of the function units with respect to a reconfigurable processor.

The compression information includes bit values that correspond to the respective function units.

The compression information generating unit is further configured to generate the compression information based on at least one of an operation code of each function unit, a predicate of a pipeline, compile information of a compiler, and user setting information.

The trace data buffer includes a plurality of memory slices, and each of the memory slices stores the valid trace data of at least one of the function units.

A number of the memory slices is less than a number of the function units, and a width of each of the memory slices is substantially the same as a size of the trace data of each of the function units.

In another general aspect, there is provided a method of storing trace data, including generating compression information to indicate the valid trace data in a trace data set. The method further includes extracting the valid trace data from the trace data set based on the compression information. The method further includes generating a write control signal with respect to the valid trace data based on the compression information. The method further includes storing the valid trace data in a trace data buffer in response to the write control signal.

The generating of the write control signal includes setting a write enable and a write address of the write control signal such that pieces of the valid trace data are stored successively in the trace data buffer without remaining space.

The method further includes storing the compression information.

The method further includes generating a read control signal with respect to the valid trace data based on the stored compression information, the read control signal including a read enable and a read address with respect to the trace data buffer.

The method further includes generating a trace packet based on the valid trace data read in response to the read control signal.

The generating of the compression information includes generating the compression information to indicate which function unit includes the valid trace data among the trace data set that includes pieces of trace data of the function units with respect to a reconfigurable processor.

The compression information includes bit values that correspond to the respective function units.

The generating of the compression information includes generating the compression information based on at least one of an operation code of each function unit, a predicate of a pipeline, compile information of a compiler, and user setting information.

The method further includes generating a trace packet including the compression information and the extracted valid trace data.

Other features and aspects may be apparent from the following detailed description, the drawings, and the claims.

### BRIEF DESCRIPTION OF THE DRAWINGS

FIG. 1 is a diagram illustrating an example of trace information.

FIG. 2 is a diagram illustrating an example of a trace data storage apparatus.

FIG. 3 is a diagram illustrating an example of a compression information generating unit.

FIG. 4 is a diagram illustrating an example of a compressing unit.

FIG. 5 is a diagram illustrating an example of a trace data buffer.

FIG. 6 is a diagram illustrating an example of a detailed trace data buffer.

FIG. 7 is a diagram illustrating an example of a compression information buffer.

FIG. 8 is a diagram illustrating an example of a write control unit.

FIG. 9 is a diagram illustrating an example of a read control unit.

FIG. 10 is a diagram illustrating an example of a trace packet generating unit.

FIG. 11 is a flowchart illustrating an example of a method of storing trace data.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

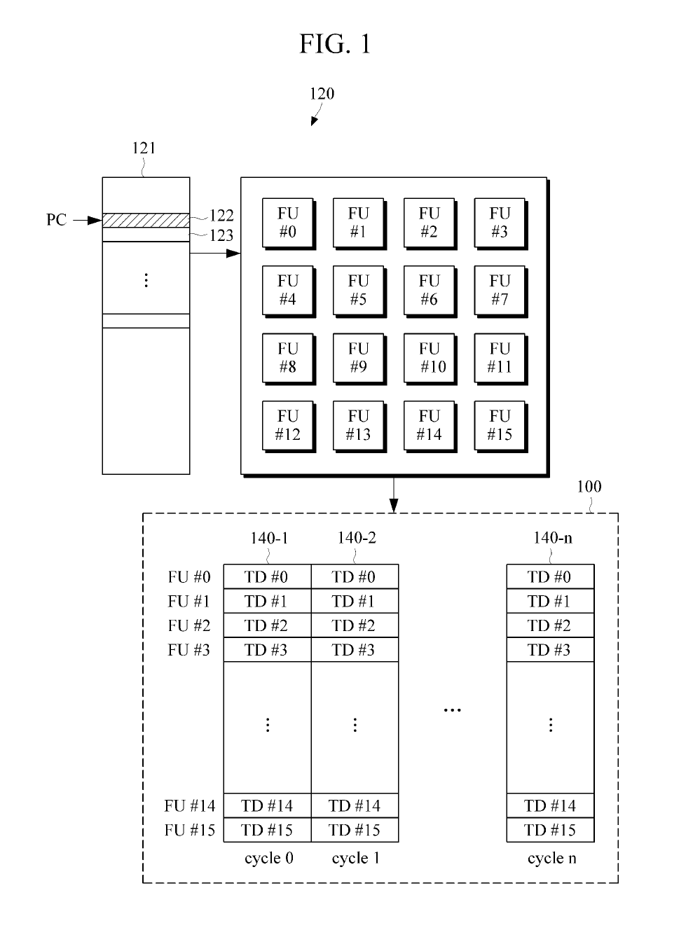

FIG. 1 is a diagram illustrating an example of trace information 100. In more detail, the trace information 100 may include trace data (TD) or a trace data set regarding a reconfigurable processor 120 (for example, a coarse-grained array (CGA)). The trace information 100 may include state information of each function unit (FU) (e.g., execution unit) included in the reconfiguration processor 120. The state information may include, for example, an input value and/or an output value of each function unit, a selection signal of a multiplexer equipped in each function unit, data of a register file included in each function unit, and memory accessibility information of each function unit.

Trace data sets 140-1, 140-2, . . . , and 140-n may be generated every predetermined trace cycle. A configuration memory 121 included in the reconfigurable processor 120 may define a connection between an instruction to be executed in each function unit and the function unit. For example, if during a first cycle a program counter (PC) indicates first configuration information 122 in the configuration memory 121, each function unit may operate according to the first configuration information 122, and as a result, a first data set 140-1 may be generated. In another example, if during a second cycle the PC indicates second configuration information 123, each function unit may operate according to the second configuration information 123, and as a result, a second trace data set 140-2 may be generated.

Each of the trace data sets 140-1, 140-2, . . . , and 140-n may include pieces of trace data (for example, TD #0 through TD #15). Each of the trace data TD #0 through TD #15 may correspond to each of the respective function units (for example, FU #0 through FU #15). For example, the trace data TD #0 may include state information of the function unit FU #0. The specific amounts of the pieces of trace data (e.g., 15) and of the function units (e.g., 15) listed above are only examples, and other amounts of the pieces of trace data and of the function units may be used depending on the particular situation.

The trace data belonging to one trace data set (for example, 140-1) may include insignificant data and significant data. For example, if during the first cycle the function unit FU #0 executes a no-operation (NOP) instruction according to the first configuration information 122, the trace data TD #0 of the function unit FU #0 may include insignificant data.

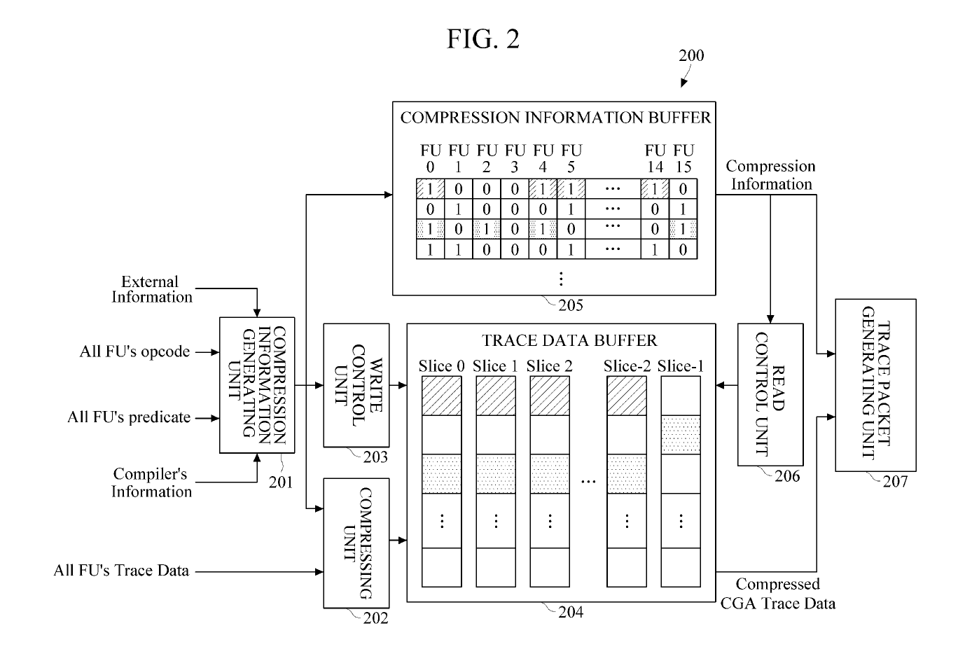

FIG. 2 is a diagram illustrating an example of a trace data storage apparatus 200. The trace data storage apparatus 200 may include a compression information generating unit 201, a compressing unit 202, a write control unit 203, a trace data buffer 204, a compression information buffer 205, a read control unit 206, and a trace packet generating unit 207.

The compression information generating unit 201 (e.g., a compression information generator) may generate compression information to indicate which trace data is valid in a trace data set. For example, the compression information generation unit 201 may generate compression information to indicate which function unit includes valid trace data among a trace data set (for example, 140-1 in FIG. 1) that includes pieces of trace data of function units with respect to a reconfigurable processor (for example, 120 in FIG. 1).

In an example, the compression information may include a bit value corresponding to each function unit. For example, in the presence of 16 function units, 16 bit regions may be defined to correspond to the respective function units, a value of a bit region corresponding to a function unit that generates significant (e.g., valid) trace data may be set to ‘1,’ and a value of another bit region may be set to ‘0’. In such a manner, the compression information may be configured.

In another example, the compression information generating unit 201 may generate the compression information using, for example, at least one of an operation code (opcode) of each function unit, a predicate of a pipeline, compile information of a compiler, and user setting information, e.g., external information. For example, if an operation code of a function unit is NOP, this may indicate that the function unit has not been scheduled, and thus, trace data of the function unit may be invalid. In addition, trace data of a function unit that is not operated by a predicate in a prologue stage or an epilogue stage of a pipeline may be invalid. Furthermore, the compression information may be generated using information about the function units that generate valid trace data according to the compiler or the user setting information.

The compressing unit 202 (e.g., a trace data controller) may receive the trace data set and the compression information every trace cycle. In addition, the compressing unit 202 may extract the valid trace data from the trace data set based on the received compression information. For example, the compressing unit 202 may classify the trace data of the received trace data set into insignificant data and significant data based on the compression information, and may select the significant data and combine them.

The write control unit 203 (e.g., the trace data controller) may generate a write control signal with respect to the trace data buffer 204. The write control signal may include a write enable and a write address for use in setting the trace data, which has been extracted by the compressing unit 202, to be successively stored in the trace data buffer 204 without remaining space. For example, if valid trace data in a trace data set is stored in a first region of the trace data buffer 204, valid trace data in another trace data set may be stored in a second region adjacent to the first region of the trace data buffer 204, so that there is no empty storage space between the first region and the second region.

The trace data buffer 204 may store the valid trace data successively based on the write control signal without remaining space.

For example, the trace data buffer 204 may include a plurality of memory slices. Each of the memory slices may store trace data of at least one function unit. The trace data buffer 204 may store valid trace data successively on a memory-slice-by-memory-slice basis according to the write control signal in order to have no empty storage space between the memory slices. For example, if three pieces of trace data have been extracted as valid trace data during a given trace cycle, the valid trace data may be stored sequentially in memory slices 0, 1, and 2.

A number of memory slices present in the trace data buffer 204 may be less than a number of function units, and a width of each memory slice may be substantially the same as a size (e.g., width) of the trace data of each function unit. A length of each memory slice may be adequately set in consideration of the size (e.g., length) of the trace data set or a size of an available memory. In another example, the trace data buffer 204 may be configured based on a circular buffer.

The compression information buffer 205 may store the compression information. For example, the compression information buffer 205 may generate an index row at each trace cycle, and may store a number of pieces of bit information that is the same as a number of the corresponding function units, in each generated index row. The bit information may indicate whether each of the corresponding function units includes valid trace data at each trace cycle. In another example, the compression information buffer 205 may be configured based on a circular buffer.

The read control unit 206 may generate a read control signal to read the trace data (e.g., the compressed CGA trace data) present in the trace data buffer 204. For example, the read control unit 206 may generate a read control signal based on the compression information present in the compression information buffer 205, e.g., such that only valid trace data is read from the trace data buffer 204. The read control signal includes a read enable and a read address with respect to the trace data to be read from the trace data buffer 204.

The trace packet generating unit 207 (e.g., a trace packet generator) may generate a trace packet including the trace data read in response to the read control signal. In an example, the trace packet generating unit 207 may generate the trace packet based on the compression information stored in the compression information buffer 205, e.g., such that only valid trace data is included in the trace packet.

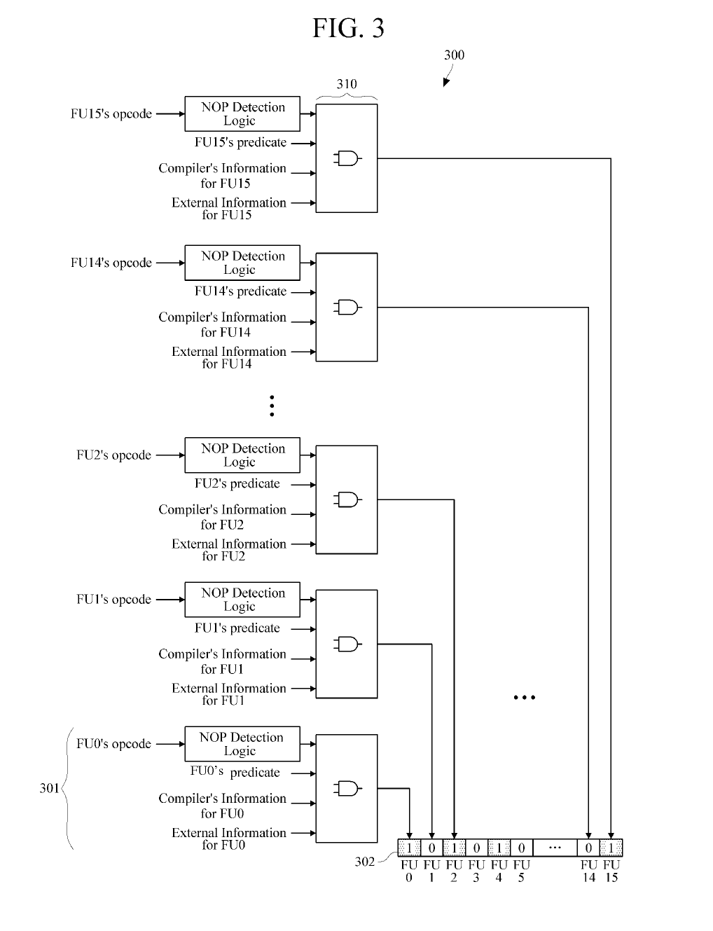

FIG. 3 is a diagram illustrating an example of a compression information generating unit 300. The compression information generating unit 300 may include operators 310 corresponding to respective function units. An input to each of the operators 310 may be connected with additional information 301 of the respective function unit, and an output from each of the operators 310 may be connected with a respective bit region of compression information 302. The additional information 301 may include, for example, at least one of an operation code, a predicate of a pipeline, compile information of a compiler, and user setting information. It should be appreciated that the additional information 301 is only for purposes of explanation, and types of information for use in determining validness of trace data may vary according to a purpose of applications. For example, if trace data of a function unit corresponding to one of the operators 310 is determined as being valid according to the additional information of the function unit, the corresponding bit region of the compression information 302 may be set to ‘1’. Otherwise, the corresponding bit region may be set to ‘0’. In an example, if an operation code of a function unit FU 0 is detected to not be an NOP instruction, the trace data of the function unit FU 0 may be determined as being valid, and the corresponding bit region of the compression information 302 may be set to ‘1’.

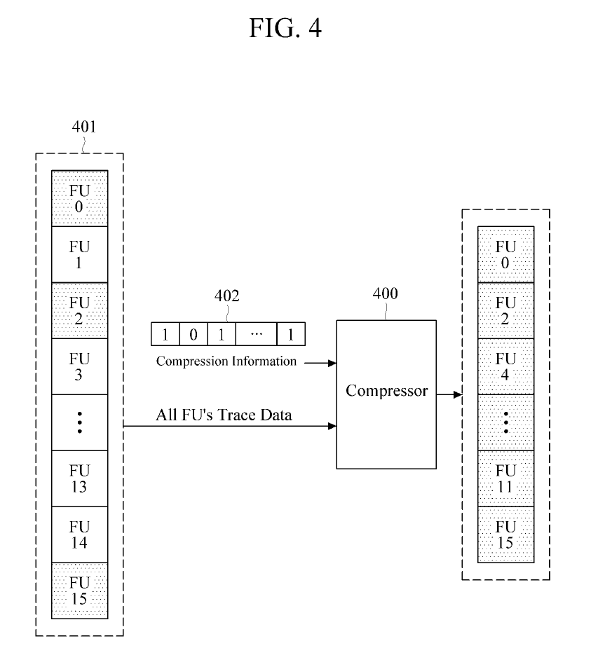

FIG. 4 is a diagram illustrating an example of a compressing unit 400. The compressing unit 400 (e.g., a compressor) may receive a trace data set 401 including trace data of function units. In addition, the compressing unit 400 may receive compression information 402 that indicates which trace data is valid in the trace data set 401. The compressing unit 400 may select only the valid trace data from the trace data set 401 based on the compression information 402, and may output the selected valid trace data. For example, first and third bits of the compression information 402 may be ‘1’, which indicates that trace data of function units FU 0 and FU 2, respectively, may be valid. Accordingly, the compressing unit 400 may extract the valid trace data of the function units FU 0 and FU 2 from the trace data set 401 based on the compression information 402.

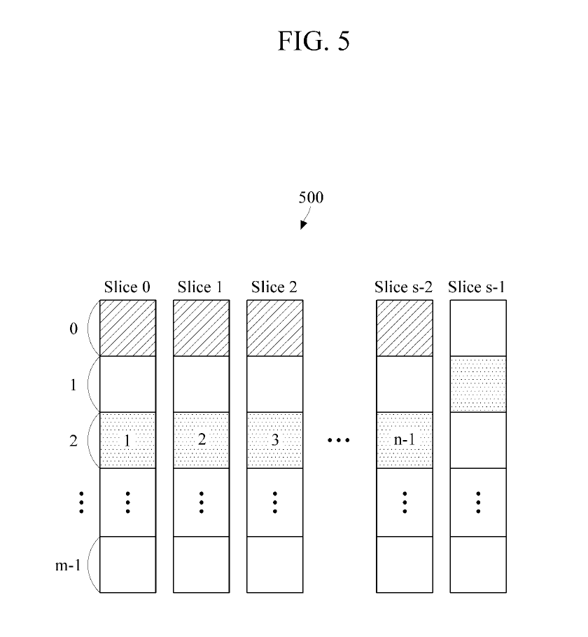

FIG. 5 is a diagram illustrating an example of a trace data buffer 500. The trace data buffer 500 may include a plurality of memory slices. A width of each of the memory slices may correspond to a size (e.g., width) of trace data of each function unit.

A number s of the memory slices may be equal to or greater than a maximum number of trace data that may be concurrently stored during a trace cycle. In addition, the number s of the memory slices may be less than or equal to a total number of the function units. For example, if there are 16 function units, up to 16 memory slices may be generated, but considering that not all of the function units generate valid trace data at one cycle, the number s of memory slices may be set appropriately within the number ‘16’.

A length m of each memory slice may correspond to the number of trace data that can be concurrently stored, and may vary according to a memory capacity or a purpose of an application. A number n of valid trace data at a trace cycle may indicate a number of valid trace data to be concurrently stored during a write operation. The number n may further indicate a number of valid trace data corresponding to a trace cycle during a read operation.

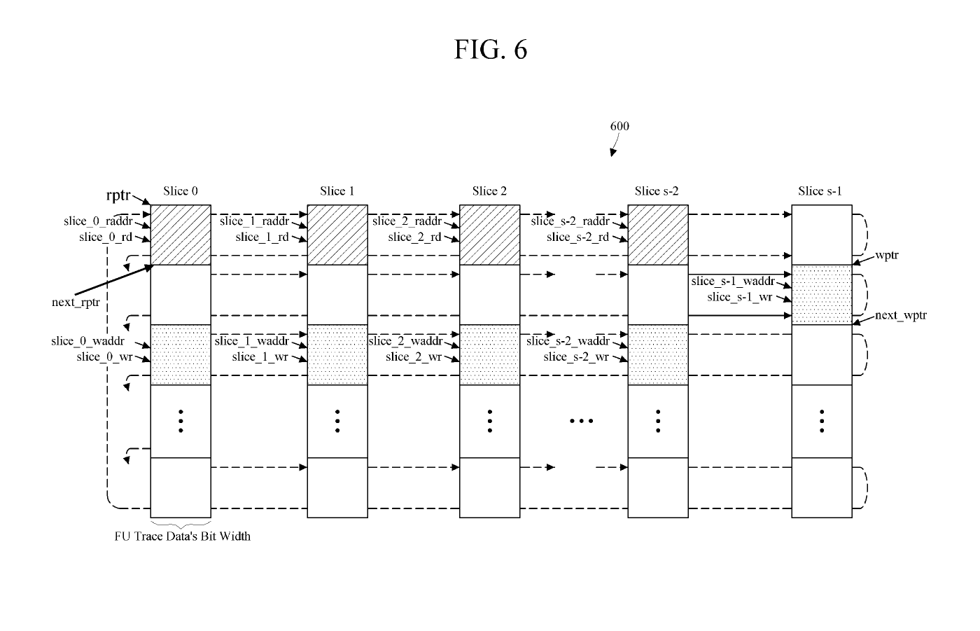

FIG. 6 is a diagram illustrating an example of a detailed trace data buffer 600. The trace data buffer 600 may include a write pointer ‘wptr’ and a read pointer ‘rptr’ based on a circular buffer that point to respective pieces of memory slice(s) to be written thereto and read therefrom, respectively. In addition, the trace data buffer 600 may include a next write pointer ‘next_wptr’ and a next read pointer ‘next_rptr’ that point to next respective pieces of the memory slice(s) to be written thereto and read therefrom, respectively.

In this example, a value of each pointer may be determined in response to a write control unit (for example, 203 in FIG. 2) or a read control unit (for example, 206 in FIG. 2). For example, a read address (e.g., ‘slice_0_raddr’), a read enable (e.g., ‘slice_0_rd’), a write address (e.g., ‘slice_0_waddr’), and a write enable (e.g., ‘slice_0_wr’) may be managed in each memory slice. The write address and the write enable, which are output from the write control unit 203, and the read address and the read enable, which are output from the read control unit 206, may be used in control of writing/reading in each memory slice. For example, the write address may point to a piece of a respective memory slice to be written thereto, and the write enable may enable a write operation to be performed to the piece of the respective memory slice.

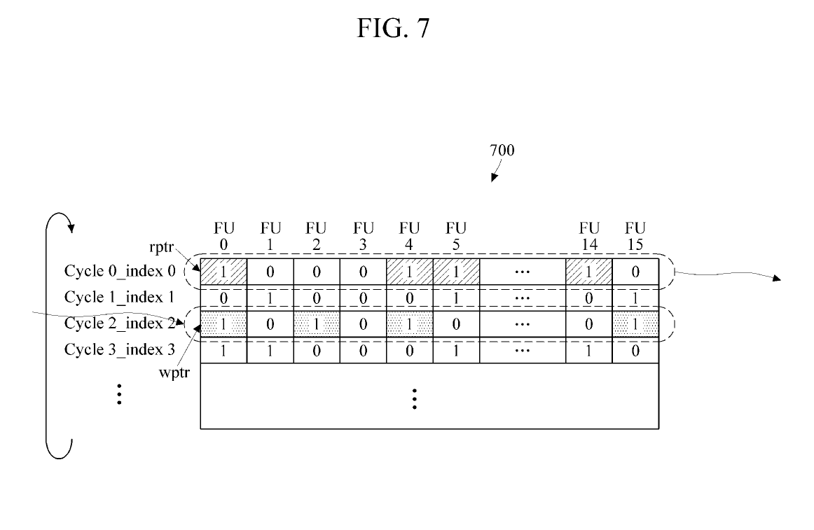

FIG. 7 is a diagram illustrating an example of a compression information buffer 700. The compression information buffer 700 may include index rows. Each index row may correspond to a trace cycle, and each index in the row may correspond to each respective function unit. For example, compression information, which is generated by the compression information generating unit (for example, 201 in FIG. 2) at each trace cycle, may be stored in each of the index rows in the compression information buffer 700. In an example, compression information generated at trace cycle 0 may be stored in an index row ‘Cycle 0_index 0’, and the index row ‘Cycle 0_index 0’ may include bit regions, each of which indicates that a corresponding function unit includes valid trace data when set to ‘1’.

In an example, the compression information buffer 700 may be provided in the form of a circular buffer. In another example, the compression information buffer 700 may manage a write pointer ‘wtpr’ and a read pointer ‘rptr’ that point to respective index rows of the compression information buffer 700 to be written thereto and read therefrom, respectively The write pointer may increase (e.g., point to a next index row) at each trace cycle, and the read pointer may increase (e.g., point to a next index row) when a trace packet generating unit (for example, 207 in FIG. 2) is able to process the trace data, e.g., generate a trace packet. In addition, the read pointer may be pointing to an index row that is lesser in value than or the same as an index row pointed to by the write pointer. If the read pointer is pointing to a same index row as the write pointer, a read operation may be performed after a write operation is completed.

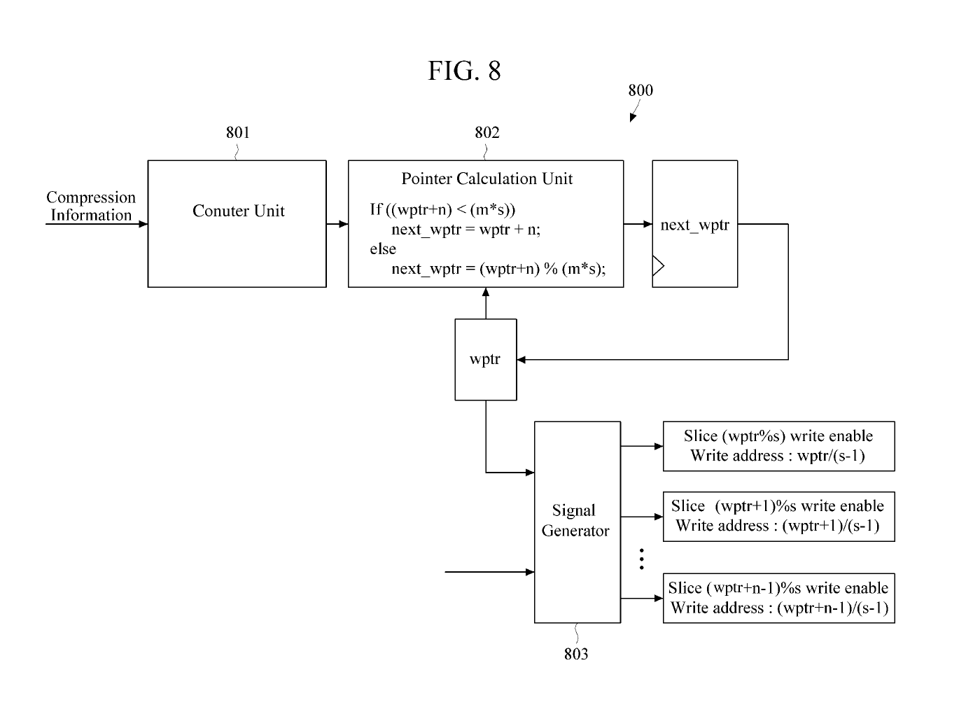

FIG. 8 is a diagram illustrating an example of a write control unit 800. The write control unit 800 may include a counter unit 801, a pointer calculation unit 802, and a signal generating unit 803.

The counter unit 801 may identify a number of valid trace data at a trace cycle based on compression information. For example, each of a plurality of bit fields in the compression information may include a ‘1’ if trace data of a mapped function unit is valid. Otherwise, the bit field may include a ‘0’. In this example, the counter unit 801 may count a number of ‘1’s to identify the number of valid trace data to be recorded. The number of valid trace data may be denoted as n.

The pointer calculation unit 802 may calculate a next write pointer ‘next_wptr’ of a trace data buffer (for example, 204 in FIG. 2) using n obtained by the counter unit 801. For example, the pointer calculation unit 802 may add n to a current write pointer ‘wptr’ to calculate the next write pointer ‘next_wptr’. In another example, since the trace data buffer may be provided in the form of a circular buffer, the pointer calculation unit 802 may perform a modulo operation (%) such that when the obtained next write pointer goes beyond an existing row in the trace data buffer, the next write pointer may indicate a next existing row in the trace data buffer. That is, when the obtained next write pointer is greater than a length m of memory slices multiplied by a number s of the memory slices, the next write pointer may be equal to the obtained next write pointer modulo the product of the length m and the number s (e.g., m*s).

The signal generating unit 803 (e.g., a signal generator) may use n and the current write pointer ‘wptr’ to generate a write enable and a write address of each memory slice in the trace data buffer. For example, the write enable may be generated for each of memory slices present between wptr % s and (wptr+n−1) % s (e.g., slice indices of the current write pointer ‘wptr’). The write address of each memory slice having the generated write enable may be calculated based on a result of dividing the slice index (wptr, wptr+1, wptr+2, . . . , wptr+(n+1)) of the corresponding memory slice by a number s−1, which is smaller by 1 than the total number s of the memory slices.

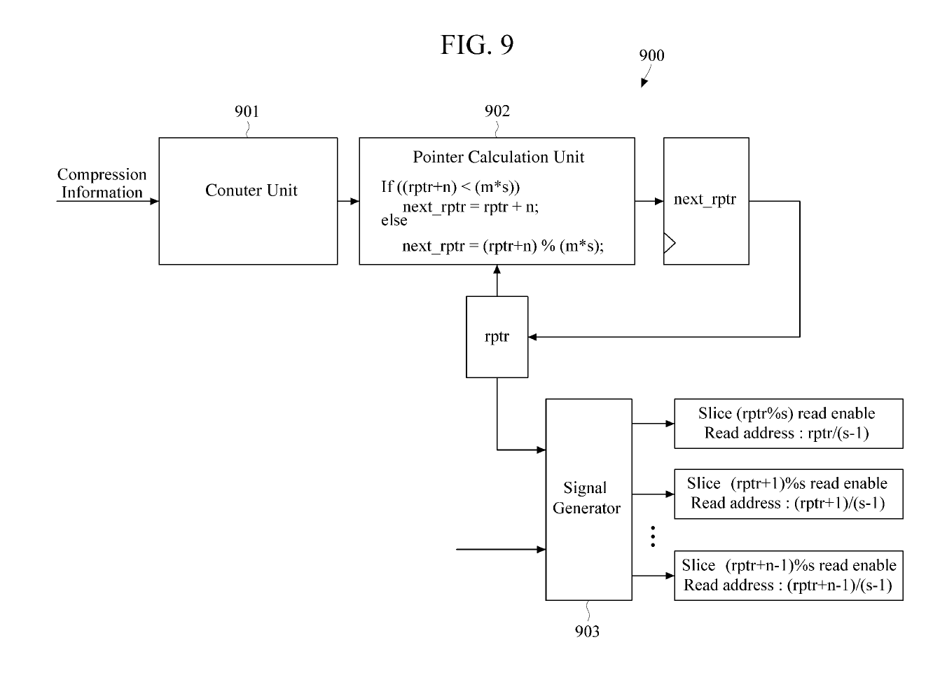

FIG. 9 is a diagram illustrating an example of a read control unit 900. The read control unit 900 may include a counter unit 901, a pointer calculation unit 902, and a signal generating unit 903.

The counter unit 901 may identify a number of valid trace data at a trace cycle based on compression information. For example, each of a plurality of bit fields in the compression information may include a ‘1’ if trace data of a mapped function unit is valid. Otherwise, the bit field may include a ‘0’. In this example, the counter unit 901 may count a number of ‘1’s to recognize the number of valid trace data to be recorded. The number of the valid trace data may be denoted as n.

The pointer calculation unit 902 may calculate a next read pointer ‘next_rptr’ of a trace data buffer (for example, 204 in FIG. 2) using the obtained n. For example, the pointer calculation unit 902 may add n to a current read pointer ‘rptr’ to calculate the next read pointer ‘next_{—rptr’.}

In another example, since the trace data buffer may be provided in the form of a circular buffer, the pointer calculation unit 902 may perform a modulo operation such that when the obtained next read pointer goes beyond an existing row in the trace data buffer, the next read pointer may indicate a next row in the trace data buffer. That is, when the obtained next read pointer is greater than a length m of memory slices multiplied by a number s of the memory slices, the next read pointer may be equal to the obtained next read pointer modulo the product of the length m and the number s (e.g., m*s).

The signal generating unit 903 (e.g., a signal generator) may calculate a read enable and a read address of each of the memory slices using n and the current read pointer ‘rptr’. For example, the read enable may be generated for each of memory slices present between rptr % s and (rptr+n−1) % s (e.g., slice indices corresponding to the current read pointer ‘rptr’). The read address of each memory slice having the generated read enable may be calculated based on a result of dividing the slice index (rptr, rptr+1, rptr+2, . . . , rptr+(n−1)) of the corresponding memory slice by a number s−1, which is smaller by 1 than the total number s of the memory slices.

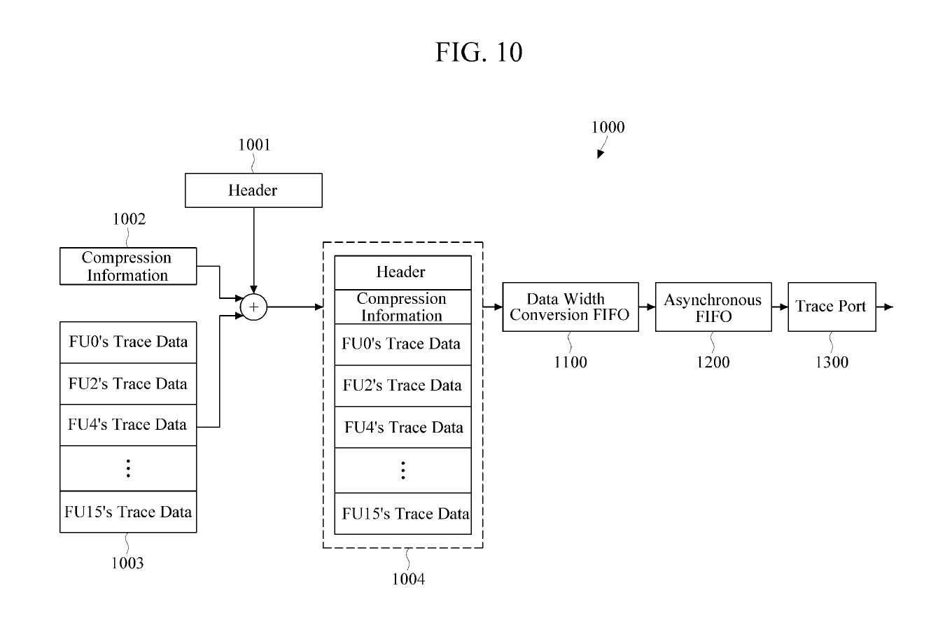

FIG. 10 is a diagram illustrating an example of a trace packet generating unit 1000. The trace packet generating unit 1000 may generate a trace packet 1004 for a corresponding trace cycle based on a predetermined header 1001, compression information 1002 being read from a compression information buffer (for example, 200 of FIG. 2), and trace information 1003 being read from a trace data buffer (for example, 204 of FIG. 2). The generated trace packet 1004 may be output through a trace port 1300.

In an example, because a bit width of the trace port 1300 may be narrower than a bit width of the trace packet 1004 and may have a different operating clock from that of the trace packet 1004, the trace packet generating unit 1000 may further include a data width conversion first in, first out (FIFO) 1100 and an asynchronous FIFO 1200. The data width conversion FIFO 1100 and the asynchronous FIFO 1200 may match the bit width and/or the operating clock of the trace port 1300, respectively, to that of the trace packet 1004.

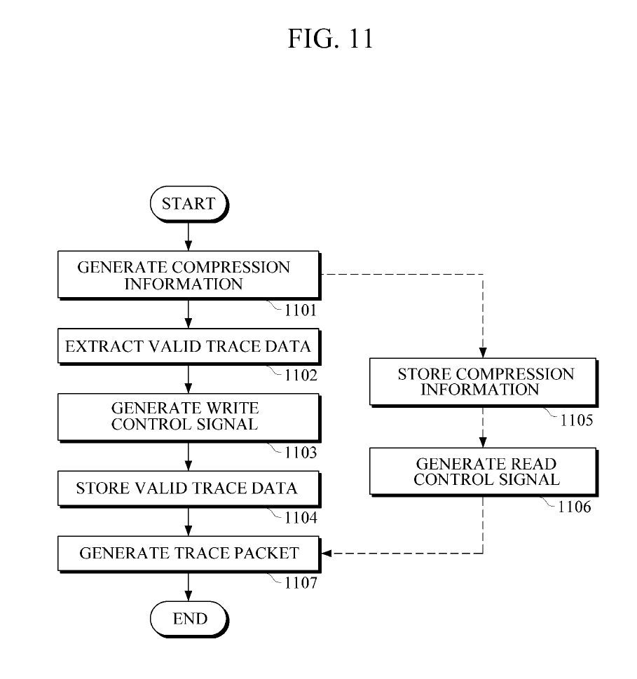

FIG. 11 is a flowchart illustrating an example of a method of storing trace data. At step 1101, compression information may be generated. The compression information may include information that indicates which trace data is valid in a trace data set by use of a bit value, where the trace data set includes a number of pieces of trace data of function units of a reconfigurable processor. For example, as shown in FIG. 3, the compression information generating unit 300 may generate the compression information 302.

At step 1102, the valid trace data may be extracted from the trace data set based on the compression information. For example, as shown in FIG. 4, the compressing unit 400 may extract the valid trace data from the trace data set 401 at a trace cycle based on the compression information 402.

At step 1103, a write control signal may be generated based on the compression information to write the valid trace data into a trace data buffer, e.g., 204 in FIG. 2. For example, as shown in FIG. 8, the write control unit 800 may generate the write control signal including a write enable and a write address based on the compression information to write the valid trace data into a trace data buffer.

At step 1104, the valid trace data may be stored in the trace data buffer based on the write control signal. For example, as shown in FIG. 6, the trace data buffer 600 may store the valid trace data in response to the write control signal.

In another example, at step 1105, the compression information may be stored. For example, as shown in FIG. 7, the compression information buffer 700 may store the compression information.

In this example, at step 1106, a read control signal may be generated based on the compression information to read the valid trace data from the trace data buffer. For example, as shown in FIG. 9, the read control unit 900 may generate a read control signal including a read enable and a read address based on the compression information to read the valid trace data from the trace data buffer.

At step 1107, a trace packet may be generated based on the compression information and the valid trace data. For example, as shown in FIG. 10, the trace packet generating unit 1000 may generate the trace packet 1004 using the predetermined header 1001, the compression information 1002, and the trace information 1003.

As described in the above examples, there is provided an architecture that may store only valid trace data based on compression information so that a size of a trace data buffer can be significantly reduced. For example, a result of implementation of the above examples has shown that a trace data buffer size may be reduced up to 84%.

The units described herein may be implemented using hardware components and software components. For example, the hardware components may include microphones, amplifiers, band-pass filters, audio to digital convertors, and processing devices. A processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable recording mediums. The computer readable recording medium may include any data storage device that can store data which can be thereafter read by a computer system or processing device. Examples of the non-transitory computer readable recording medium include read-only memory (ROM), random-access memory (RAM), CD-ROMs, magnetic tapes, floppy disks, optical data storage devices. Also, functional programs, codes, and code segments for accomplishing the example embodiments disclosed herein can be easily construed by programmers skilled in the art to which the embodiments pertain based on and using the flow diagrams and block diagrams of the figures and their corresponding descriptions as provided herein.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus configured to store valid trace data, comprising:
a compression information generating unit configured to generate compression information to indicate the valid trace data in a trace data set;
a compressing unit configured to extract the valid trace data from the trace data set based on the compression information;
a write control unit configured to generate a write control signal for use in writing the valid trace data based on the compression information; and
a trace data buffer configured to store the valid trace data in response to the write control signal.

2. The apparatus of claim 1, wherein the write control unit is further configured to generate the write control signal such that a number of the valid trace data are successively stored in the trace data buffer without remaining space.

3. The apparatus of claim 2, wherein the write control signal comprises a write enable and a write address with respect to the trace data buffer.

4. The apparatus of claim 1, further comprising a compression information buffer configured to store the compression information.

5. The apparatus of claim 4, further comprising a read control unit configured to generate a read control signal for use in reading the valid trace data based on the compression information stored in the compression information buffer, the read control signal comprising a read enable and a read address with respect to the trace data buffer.

6. The apparatus of claim 5, further comprising a trace packet generating unit configured to generate a trace packet based on the valid trace data read in response to the read control signal.

7. The apparatus of claim 1, wherein the compression information generating unit is further configured to generate the compression information to indicate which function unit comprises the valid trace data among the trace data set that comprises pieces of trace data of the function units with respect to a reconfigurable processor.

8. The apparatus of claim 7, wherein the compression information comprises bit values that correspond to the respective function units.

9. The apparatus of claim 7, wherein the compression information generating unit is further configured to generate the compression information based on at least one of an operation code of each function unit, a predicate of a pipeline, compile information of a compiler, and user setting information.

10. The apparatus of claim 7, wherein the trace data buffer comprises a plurality of memory slices, and each of the memory slices stores the valid trace data of at least one of the function units.

11. The apparatus of claim 10, wherein a number of the memory slices is less than a number of the function units, and a width of each of the memory slices is substantially the same as a size of the trace data of each of the function units.

12. A method of storing valid trace data, comprising:
generating compression information to indicate the valid trace data in a trace data set;
extracting the valid trace data from the trace data set based on the compression information;
generating a write control signal with respect to the valid trace data based on the compression information; and
storing the valid trace data in a trace data buffer in response to the write control signal.

13. The method of claim 12, wherein the generating of the write control signal comprises setting a write enable and a write address of the write control signal such that pieces of the valid trace data are stored successively in the trace data buffer without remaining space.

14. The method of claim 12, further comprising storing the compression information.

15. The method of claim 14, further comprising generating a read control signal with respect to the valid trace data based on the stored compression information, the read control signal comprising a read enable and a read address with respect to the trace data buffer.

16. The method of claim 15, further comprising generating a trace packet based on the valid trace data read in response to the read control signal.

17. The method of claim 12, wherein the generating of the compression information comprises generating the compression information to indicate which function unit comprises the valid trace data among the trace data set that comprises pieces of trace data of the function units with respect to a reconfigurable processor.

18. The method of claim 17, wherein the compression information comprises bit values that correspond to the respective function units.

19. The method of claim 17, wherein the generating of the compression information comprises generating the compression information based on at least one of an operation code of each function unit, a predicate of a pipeline, compile information of a compiler, and user setting information.

20. The method of claim 12, further comprising generating a trace packet comprising the compression information and the extracted valid trace data.
